(19) United States
(12) Patent Application Publication
(10) Pub. No.: US 2025/0155205 A1
(43) Pub. Date: May 15, 2025

(54) HEAT TRANSFER ENHANCEMENT USING PARAMETRIC ELECTROSTATIC FORCING

(71) Applicant: University of Florida Research Foundation, Inc., Gainesville, FL (US)

(72) Inventors: Ranganathan Narayanan, Gainesville, FL (US); William O'Brien, Gainesville, FL (US); Jason D. Livesay, Gainesville, FL (US); Thomas Corbin, Gainesville, FL (US)

(21) Appl. No.: 19/022,336

(22) Filed: Jan. 15, 2025

Related U.S. Application Data
(63) Continuation-in-part of application No. PCT/US2023/070234, filed on Jul. 14, 2023.
(60) Provisional application No. 63/389,824, filed on Jul. 15, 2022.
(60) Provisional application No. 63/423,586, filed on Nov. 8, 2022.

(51) Int. Cl. F28F 13/16; F28D 15/02; F28D 21/00

(52) U.S. Cl. CPC F28F 13/16; F28D 15/025; F28D 2021/0021

(57) ABSTRACT

Various examples are provided related to heat transfer enhancement using parametric electrostatic forcing. In one example, a heat transfer system includes a cell including fluids; an aluminum electrode clamped on a first side of the cell; and an ITO-coated glass electrode clamped on a second side of the cell. AC excitation of the aluminum electrode and the ITO-coated electrode produces AC electrostatic fields that resonate the fluids enhancing heat transfer across the cell. The heat transfer system can be operated in microgravity environments without gravity driven buoyancy.

### CROSS REFERENCE TO RELATED APPLICATIONS

This application claims priority to, and the benefit of, PCT Application No. PCT/US2023/070234, filed Jul. 14, 2023, which claims priority to, and the benefit of, U.S. provisional application entitled “Heat Transfer Enhancement Using Parametric Electrostatic Forcing” having Ser. No. 63/389,824, filed Jul. 15, 2022, and U.S. provisional application entitled “Heat Transfer Enhancement Using Parametric Electrostatic Forcing” having Ser. No. 63/423,586, filed Nov. 8, 2022, all of which are hereby incorporated by reference in their entireties.

### STATEMENT REGARDING FEDERALLY SPONSORED RESEARCH OR DEVELOPMENT

This invention was made with government support under Grant No. 80NSSC 20M0093, awarded by the National Aeronautics and Space Administration under a subaward from the University of Central Florida; Grant No. 80NSSC 21K0352, awarded by the National Aeronautics and Space Administration; and Grant No. 2025117, awarded by the National Science Foundation. The government has certain rights in the invention.

### BACKGROUND

Heat transfer in microgravity is currently limited on account of the absence of buoyancy driven convection. Consequently, many conventional heat transfer approaches on Earth which utilize buoyancy driven flow do not work in space, particularly in closed-loop systems without the use of external pumps.

### SUMMARY

Aspects of the present disclosure are related to heat transfer enhancement using parametric electrostatic forcing. In one aspect, among others, a heat transfer system comprises a cell comprising fluids; an aluminum electrode clamped on a first side of the cell; and an ITO-coated glass electrode clamped on a second side of the cell; wherein AC excitation of the aluminum electrode and the ITO-coated electrode produces AC electrostatic fields that resonate the fluids enhancing heat transfer across the cell. The heat transfer system can comprise a first electrically insulating and thermally conducting material positioned on a side of the aluminum electrode opposite the cell and a second electrically insulating and thermally conducting material positioned on a side of the ITO-coated glass electrode opposite the cell. The first and second electrically insulating and thermally conducting materials can be sapphire.

In one or more aspects, the heat transfer system can comprise a first water bath positioned on a side of the first electrically insulating and thermally conducting material opposite the aluminum electrode and a second water bath positioned on a side of the second electrically insulating and thermally conducting material opposite the ITO-coated electrode. The second water bath can be sealed by the second electrically insulating and thermally conducting material using a clamp. The cell can be secured between the aluminum electrode and the ITO-coated glass electrode using a second clamp. Both clamps can have low thermal conductivity. The clamps can be PLA (polylactic acid) clamps. The first and second water baths can be fabricated of resin.

In various aspects, the heat transfer system can comprise a heat flow sensor. The heat flow sensor can be located between the aluminum electrode and a first water bath positioned on a side of the aluminum electrode opposite the cell. The heat flow sensor can be secured between electrically insulating and thermally conducting material. The cell can be a polycarbonate test cell. The cell can comprise a first fluid having a first density and a second fluid having a second density greater than the first density. The first fluid can be an oil and the second fluid can be water. The oil can be a silicone oil. The ratio of the first fluid to the second fluid can be in a range from about 30:70 to about 70:30. The ratio can be a height ratio in the cell. The AC excitation can be provided in a range from about 0.5 Hz to about 5 Hz. The AC excitation can be applied to the aluminum electrode and the ITO-coated electrode in a microgravity environment without gravity driven buoyancy.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of an oscillating heat pipe design, in accordance with various embodiments of the present disclosure.

FIG. 2 schematically illustrates an example of wavelike patterns on fluid interface above the critical amplitude, in accordance with various embodiments of the present disclosure.

FIG. 3 schematically illustrates an example of forced convective wave patterns, in accordance with various embodiments of the present disclosure.

FIGS. 4A and 4B illustrate an example of the proposed heat transfer system, in accordance with various embodiments of the present disclosure.

FIG. 5 schematically illustrates an example of test cell dimensions for test 1, in accordance with various embodiments of the present disclosure.

FIG. 6 illustrates an example of dependence of heat flux on the ratio of fluid heights, in accordance with various embodiments of the present disclosure.

FIGS. 7A-7F, 8A-8F and 9A-9F illustrate examples of heat flux under various conditions with tests 1, 2 and 3, respectively, in accordance with various embodiments of the present disclosure.

FIG. 10 illustrates an example of long term heat flux increase with test 3, in accordance with various embodiments of the present disclosure.

FIGS. 11A-11D illustrate examples of heat flux under various conditions for another test, in accordance with various embodiments of the present disclosure.

FIGS. 12A-12C illustrate an example of a multi-unit system for flight testing, in accordance with various embodiments of the present disclosure.

FIG. 13 is an image of a fabricated multi-unit system of FIGS. 12A-12C used for flight testing, in accordance with various embodiments of the present disclosure.

FIGS. 14A-14D are plots illustrating heat transfer improvements observed under microgravity compared to terrestrial gravity conditions in the multi-unit system, in accordance with various embodiments of the present disclosure.

FIGS. 15A-15C are plots illustrating heat transfer improvements observed under lunar gravity compared to terrestrial gravity conditions in the multi-unit system, in accordance with various embodiments of the present disclosure.

### DETAILED DESCRIPTION

Disclosed herein are various examples related to heat transfer enhancement using parametric electrostatic forcing. Electrostatic resonance can enhance heat transfer in microgravity. In the current study it is suggested to use resonance, by vibrational acceleration until the imposed frequency resonates with the fluid system's natural frequency, causing substantial motion in the fluid. While mechanically induced resonance has been shown to substantially enhance heat transfer, it is of limited practical use. However imposed acceleration by AC electrostatic fields have yielded preliminary data that show a substantial increase in the heat flux. Here, a method of utilizing this novel means of resonant-induced flow is discussed. Optimization of these parameters such as height, diameter, fluids, and transitioning from a single-phase system to a two-phase system can provide a further increase in heat flux. Reference will now be made in detail to the description of the embodiments as illustrated in the drawings, wherein like reference numbers indicate like parts throughout the several views.

As high-powered electronics become smaller and more powerful, more heat must be dissipated properly. Local high heat flux components are placed next to these electronic devices to facilitate the removal of heat and avoid high temperatures that can degrade the performance of the electronics. A novel method for enhancement of heat transfer through electrostatic forcing is disclosed. The technology has its application to microgravity because in zero gravity there is no buoyancy driven convection. Therefore, an alternative fluid flow method is needed to enhance the heat transfer. In this disclosure, a proof-of-concept is given wherein resonance-induced vibrational acceleration is used such that the imposed frequency resonates with the fluid system's natural frequency, causing substantial motion in the fluid. The imposed acceleration is induced by AC electrostatic fields. Increase in heat flux over conduction is reported under various operating conditions proving the concept of resonance-induced enhancement.

Current thermal management can be broken down into active or passive thermal control systems. Active thermal control systems need a power input to operate, whereas passive thermal control systems do not. Active thermal control systems typically involve pumped fluid systems. Advantages of such a system include a decreased sensitivity to pressure drop and increased control over flowrate. These combine to allow increased heat flux and robustness. The single-phase active system involves a heat exchanger mounted to the heat source (typically an electronic component) and is pumped away to a heat sink. A similar active thermal control system is a two-phase system. The two-phase active system allows for even greater heat flux because such a system uses the latent heat of vaporization rather than the sensible heat of a fluid. This system operates similarly but the liquid is allowed to evaporate at the heat exchanger and condense at the heat sink. Ultimately, with either single or two-phase systems, the active systems typically achieve a more precise temperature control within allowable margins.

However, a glaring disadvantage of active systems is the mechanical pump associated with such a system. The pump requires an electrical input that consumes part of the spacecraft's power budget. Such systems typically have a larger mass and volume associated with them as well. Also of concern, cavitation can occur in pumped system, especially in two phase flow. This brings into question the mechanical dependability of the pump itself. Cavitation wears down mechanical parts and introduces possible system failures. In space, such a failure is magnified greatly.

Alternatively, passive thermal control systems do not involve mechanical pumps or any power input to operate. Advantages of these systems include no electrical power input and lowered costs, volume, and mass. Most importantly, passive systems do not use mechanical pumps and therefore have a lower risk of system failure. Thermal straps are an example of a passive control system in use today aboard spacecrafts. They are simply thermally conductive connectors between a heat source and a heat sink. Traditionally they are made of lightweight metals such as copper and aluminum, but other materials such as graphite have been shown to have enhanced conductivity. The disadvantage is that they are limited by the conductivity of the strap material and only utilize sensible heat.

Heat pipes are another passive thermal control system. Heat pipes are two-phase systems with a working fluid enclosed by a metal pipe. There is a porous wick-like structure on the inside surface of the metal pipe. The pipe is attached to a heat source (evaporator section) and a heat sink (condenser section). At the heat source, the working fluid evaporates while utilizing the latent heat of vaporization to maximize heat exchange and the vapor travels to the heat sink region where it condenses, once again utilizing latent heat. The liquid then travels back to the evaporator section by means of capillary action through the wick-like structure.

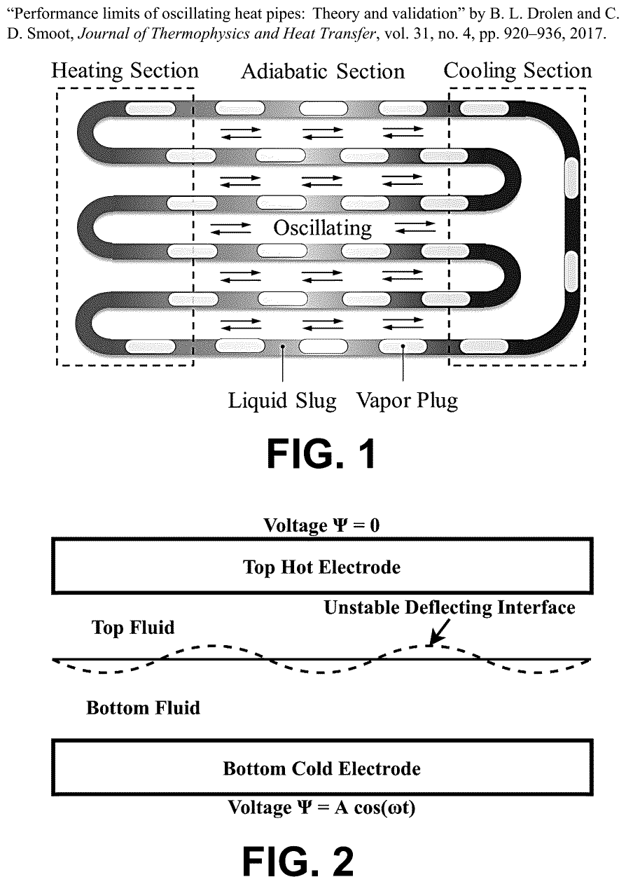

An oscillating heat or a pulsating heat pipe operates similarly, but instead has a serpentine capillary channel in which the channel is evacuated and then working fluid is partially filled, forming an alternating pattern of liquid slugs and vapor bubbles. At the heat sink, evaporation occurs, and a local pressure increase pushes the liquid slug away from the heat sink. Due to the serpentine structure, this also pushes other slugs and bubbles into the evaporator region and this process repeats itself, thus giving way to the apt naming of the system. The design of a typical OHP is shown in FIG. 1.

Both heat pipe passive systems include the additional advantage of high heat transfer through the use of the latent heat of vaporization of the working fluid. Disadvantages of heat pipes include limitations such as the minimum startup heat flux to begin nucleate boiling and to initiate phase changes. Once startup is attained, heat flux must then remain below the critical heat flux value for the system, otherwise the system will transition to film boiling reducing the effective heat transfer. Conventional heat pipes also must rely on the low capillary pumping capability. Another important note is that heat pipes must avoid dry out conditions in which heat transfer ceases.

The proposed heat transfer system is a novel active thermal management control system with a waveform generator and amplifier as an electrical input. There are no mechanical pumps required, thereby significantly reducing the chances of system failure via cavitation from bubble formation. There is reliable fluid motion with the applied AC electrostatic field. This combination offers advantages of some of the discussed active and passive thermal management systems.

Physics of the Technology. Consider an analog to the electrostatically forced Faraday system, which is the mechanically forced Faraday problem. In this system, two fluids are held in a container and are moved back and forth vertically at a defined frequency and at a certain height, the amplitude of the system. For a certain fluid combination at a given frequency, there is a critical amplitude such that any amplitude above this critical amplitude results in vigorous fluid motion and wavelike patterns at the fluid interface. These response patterns are known as Faraday waves and can be defined as modes which can be determined.

An electrostatically forced Faraday system is similar. Once again, the system has fluids in a container. However, instead of mechanically moving up and down at a given frequency and height, an AC signal is input. This input contains the frequency and voltage. At a certain frequency, there is a voltage amplitude at which vigorous motion and Faraday waves will appear at the fluid interface. This is known as the critical amplitude. A schematic of this is shown in FIG. 2.

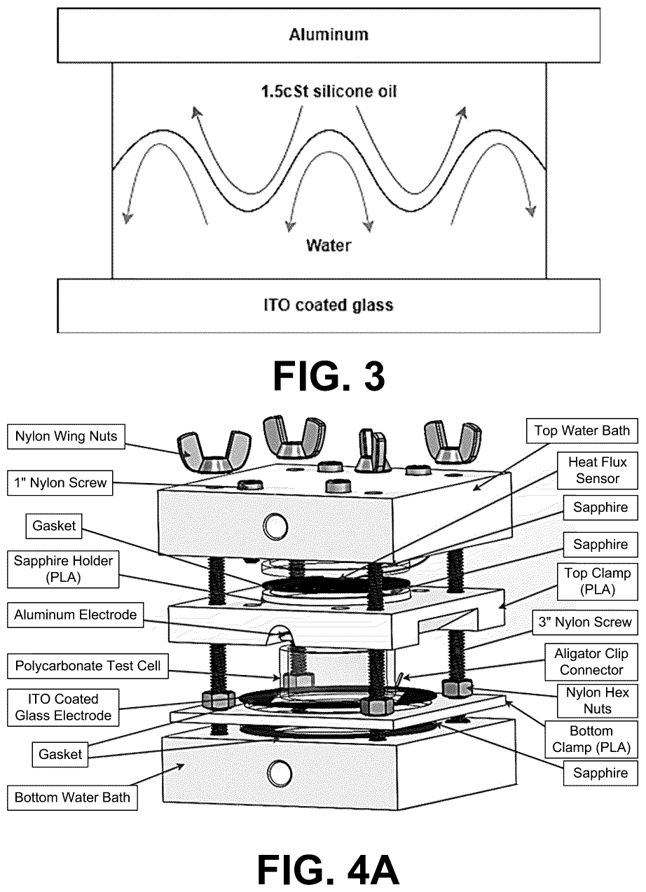

Convective heat transfer occurs through the movement of a liquid or gas. The motion offers a unique advantage in that it maintains a steeper temperature gradient, whereas heat transfer through conduction does not. Convection can either be natural or forced. Natural convection has no external force to cause the motion of the liquid or gas. It depends on gravity driven buoyancy, which as mentioned previously does not occur in microgravity. This creates the challenge of creating convective heat transfer through other ways. This means forced convection is used. Here, electrostatically forced convection will be discussed. The imposed amplitude across the fluids causes substantial motion once the critical amplitude has been crossed. A schematic of this is shown in FIG. 3.

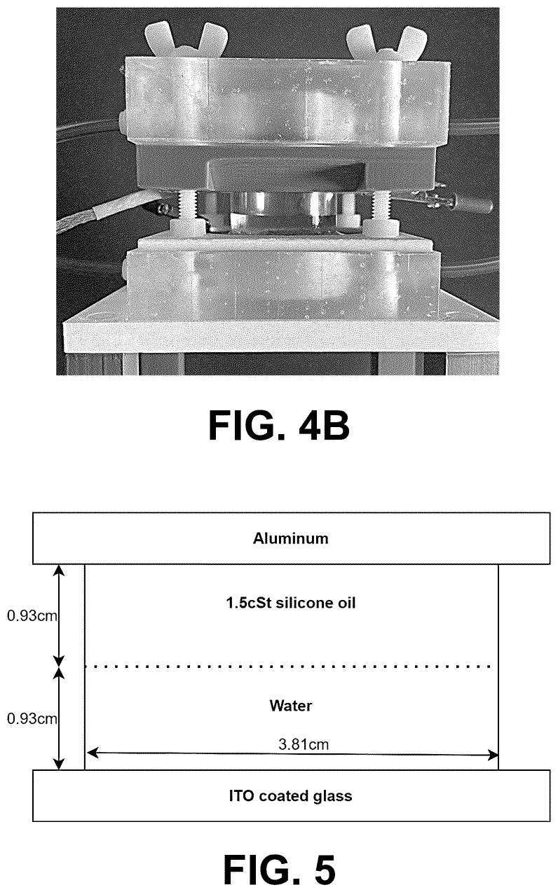

Experimental Setup. FIG. 4A shows a schematic of the current system and FIG. 4B is an image of the physical system. The top and bottom water baths hold the top and bottom at a constant temperature. The polycarbonate test cell contains the two fluids, with the aluminum electrode as the top boundary and the ITO (indium tin oxide) coated glass electrode as the bottom boundary. ITO coated glass is transparent, allowing for viewing of the fluid interface from the bottom of the system. The top PLA (polylactic acid) clamp was designed, and 3-D printed, to house the sensor between sapphire pieces and the aluminum electrode. This is compression fit into the top water bath made of resin with the 1″ nylon screws. The bottom PLA clamp holds the bottom sapphire down with nylon hex nuts, sealing the bottom resin water bath. The test cell connected to the ITO coated glass sits on the sapphire. The top PLA housing and resin bath are then placed on the test cell so that the aluminum electrode touches the top of the test cell. The 3″ nylon screws are then hand tightened with the nylon wing nuts. This creates a compression fit sealed system. To operate the system, a voltage and frequency are input across the electrodes to cause wavelike patterns increasing the heat flux, which is measured with the sensor.

Thermal Design Aspect. The thermal design of the system will now be discussed. The top and bottom water baths were designed and resin printed. They hold the top hot side and cold bottom side at constant temperatures Tₕ and T_{c}. On the bottom side, the water is in contact with sapphire that has good thermal conductivity allowing the heat from the water bath to be passed on. Above the sapphire is the ITO coated glass which acts as the bottom electrode. The glass has low thermal conductivity but due to its thin nature, it will not impede heat transfer significantly.

Switching to the top side of the system, the water at Tₕ is in contact with the sapphire. A heat flux sensor (e.g., from FluxTeq) is positioned between another piece of sapphire and the sapphire in contact with the water. This allows for the determination of the heat flux of system. Below the sapphire is an aluminum piece that acts as the top electrode. Aluminum has excellent thermal conductivity. Between the ITO coated glass and the aluminum is the two fluid system encased by a polycarbonate test cell with very low thermal conductivity. Additionally, the PLA clamps and resin both have low thermal conductivity. In this configuration, the system does not lose substantial heat to its surroundings and the heat flux can be accurately measure.

Electrical Design Aspect. Looking at the system from an electrical point of view, a system of a ground electrode and a live electrode is constructed and provides a circuit through the fluids. One fluid must be a good conductor, while one fluid must be a good insulator. The ground electrode is the aluminum top electrode, while the live electrode is the ITO coated glass. Both above the aluminum electrode and below the ITO coated glass electrode are pieces of sapphire, which is a good electric insulator. This directs the electricity to flow through the fluids as intended. The leads are connected to a voltage amplifier (e.g., a Trek Model 609B 1000× voltage amplifier). The input can be provided by a function waveform generator (e.g., a Siglent 30 MHz function waveform generator). It allows for input frequencies and voltages.

Experimental Results. A first set of trials was conducted for two primary reasons. First, to confirm that there would be an increase in heat flux at and above the onset of forced fluid motion. Second, to optimize the height ratio of two fluids at a given test cell height. For all of the trials conducted in this disclosure, the difference in temperature was 10° C. The hot temperature at the top, known as Tₕ, was 40° C. It was kept constant through the use of a water circulating bath (e.g., a Neslab EX-200DD water circulating bath). The bottom cold temperature, known as T_{c}, was 30° C. It was kept constant using another water circulating bath (e.g., a MGW Lauda C3 water circulating bath).

The heavy fluid, or the one with a greater density residing on the bottom of the cell, in this experiment was water and it was the conducting fluid. The light fluid was 1.5 cSt silicone oil, and it acted as the dielectric. The polycarbonate test cell (e.g., from McMaster-Carr) had dimensions comprising a height of 1.86 cm and an inner diameter of 1.5″ (3.81 cm). The first test was conducted with a height ratio of water:silicone oil of 50:50. Both fluids had a resting layer height of 0.93 cm. This test configuration is illustrated in FIG. 5 bounded by the electrodes (aluminum and ITO coated glass).

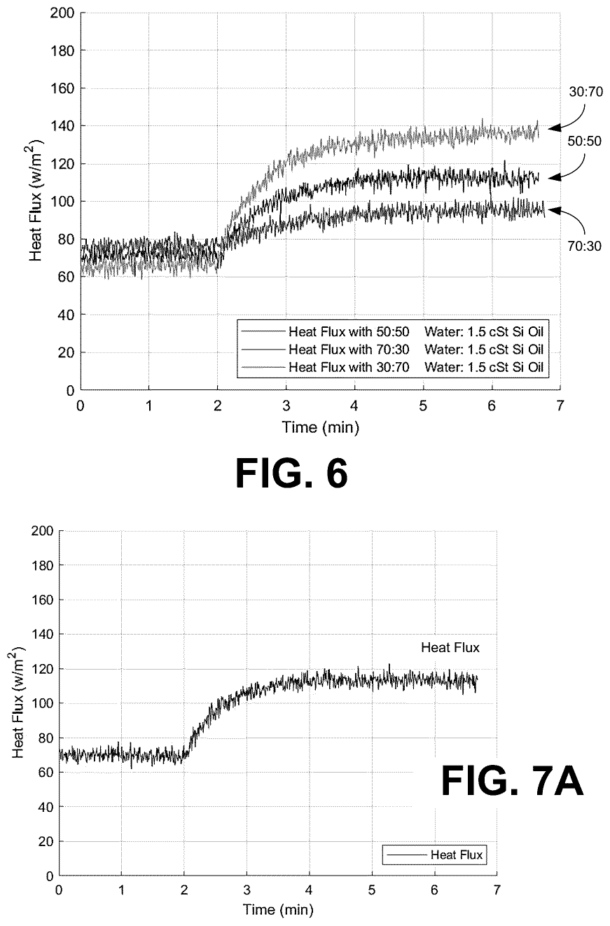

The second test was conducted with a height ratio of water:silicone oil of 70:30. The height of the water was 1.30 cm, and the height of the silicone oil was 0.56 cm. The third test was conducted with a height ratio of water:silicone oil of 30:70. The height of the water was 0.56 cm and the height of the silicone oil was 1.30 cm. These three tests will be referred to as Test 1, Test 2, and Test 3, respectively. The tests were run for just under seven minutes total. The first two minutes were run without any electric field being applied so it was without any forced fluid flow. This is the base state at which there is a base heat flux. At the two-minute mark, the voltage was applied and wavelike motion appeared on the fluid interface. This coincides with the increase in heat flux. Data across these three tests at a frequency of 1 Hz is shown in FIG. 6. A summary of data is shown in Table 1.

TABLE 1
Heat flux increase between water and 1.5 cSt silicone oil

| | Heat Flux | Heat Flux | Heat Flux |
|---|---|---|---|
| Frequency | Increase | Increase | Increase |
| (Hz) | Test 1 (%) | Test 2 (%) | Test 3 (%) |
| 0.5 | 69 | 38 | 79 |
| 1.0 | 57 | 27 | 109 |
| 2.0 | 71 | 17 | 93 |
| 3.0 | 56 | 24 | 106 |
| 4.0 | 72 | 27 | 91 |
| 5.0 | 75 | 27 | 94 |
| Average | 66.7 | 26.7 | 95.3 |

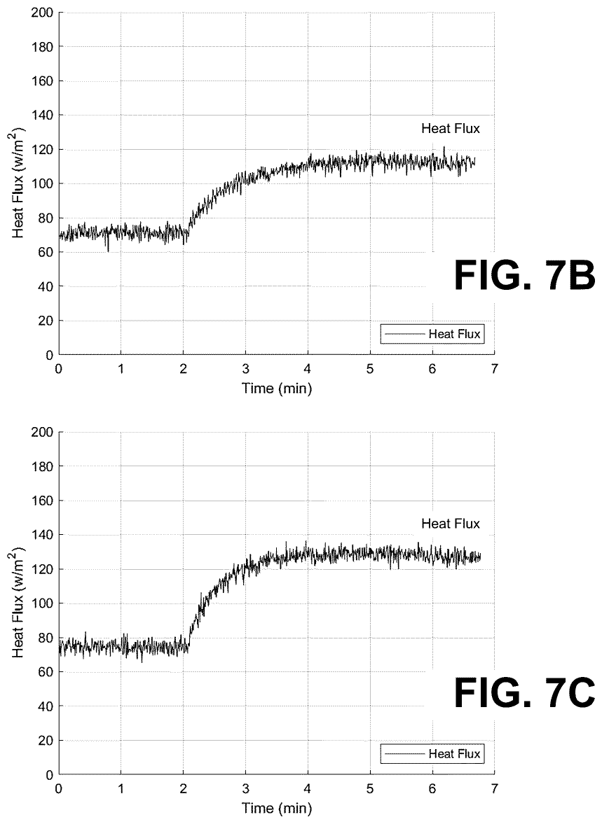

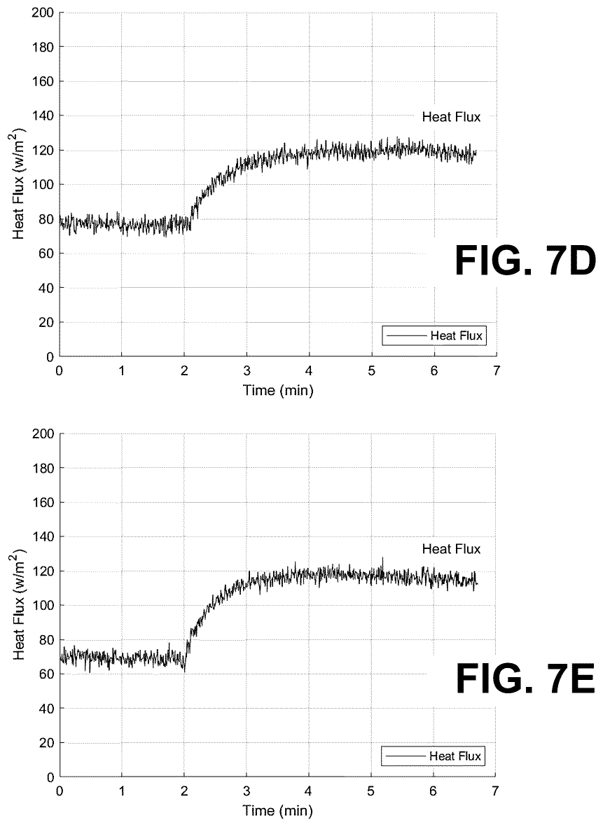

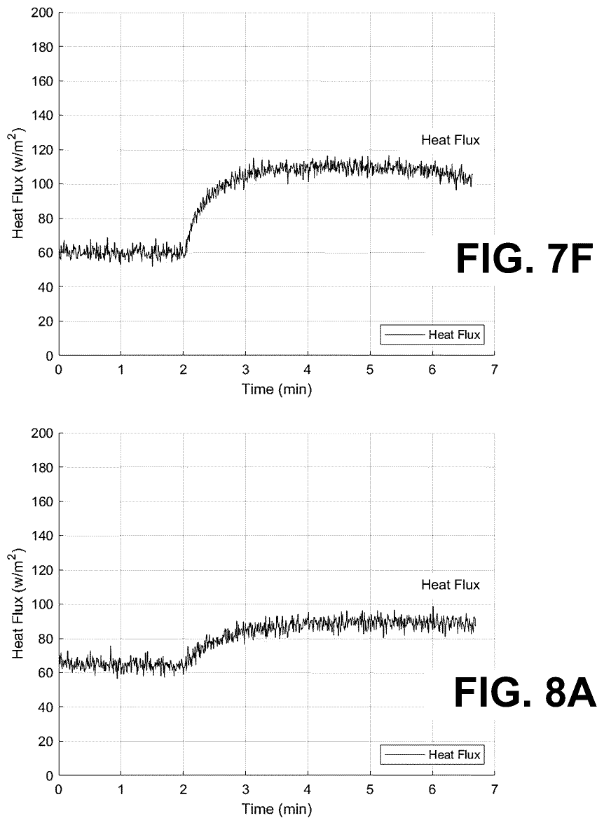

The increase in heat flux was calculated by taking the difference between the increased heat flux (the one with forced fluid motion) and the base state heat flux (the one with no forced fluid motion) and dividing by the base state heat flux. Base state heat flux can vary slightly from trial to trial due to different fluid levels and slight variations in water bath temperature. The heat fluxes can be read off the graphs in FIGS. 7A-7F (test 1), 8A-8F (test 2), and 9A-9F (test 3).

FIG. 7A shows the heat flux for test 1 (0.93 cm water: 0.93 cm 1.5 cSt silicone oil) at 0.5 Hz and 9.2 kVpp. FIG. 7B shows the heat flux for test 1 (0.93 cm water: 0.93 cm 1.5 cSt silicone oil) at 1.0 Hz and 8.5 kVpp. FIG. 7C shows the heat flux for test 1 (0.93 cm water: 0.93 cm 1.5 cSt silicone oil) at 2.0 Hz and 9.9 kVpp. FIG. 7D shows the heat flux for test 1 (0.93 cm water: 0.93 cm 1.5 cSt silicone oil) at 3.0 Hz and 9.4 kVpp. FIG. 7E shows the heat flux for test 1 (0.93 cm water: 0.93 cm 1.5 cSt silicone oil) at 4.0 Hz and 10.5 kVpp. FIG. 7F shows the heat flux for test 1 (0.93 cm water: 0.93 cm 1.5 cSt silicone oil) at 5.0 Hz and 12.3 kVpp.

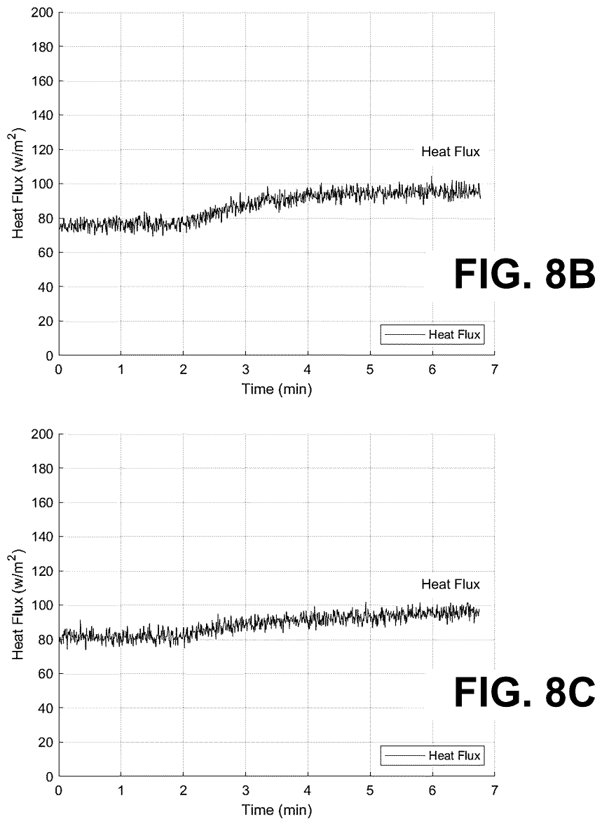

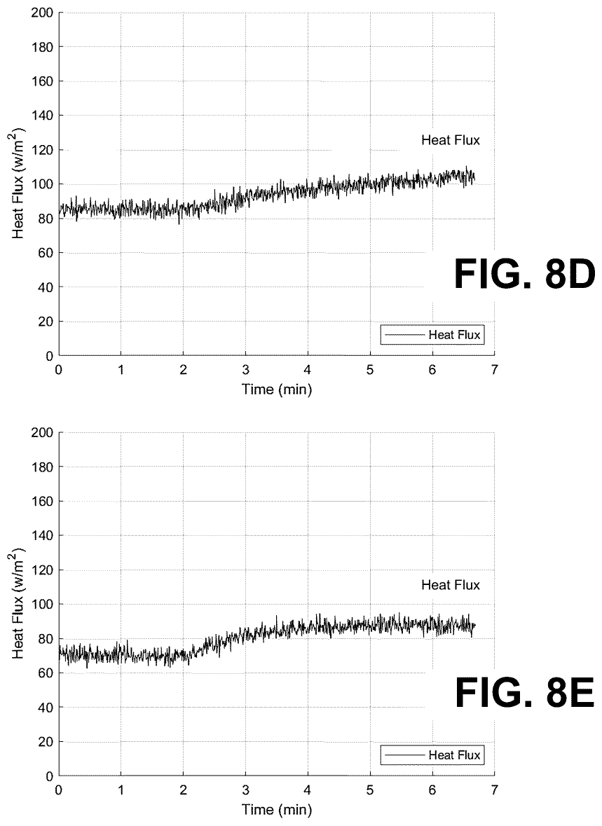

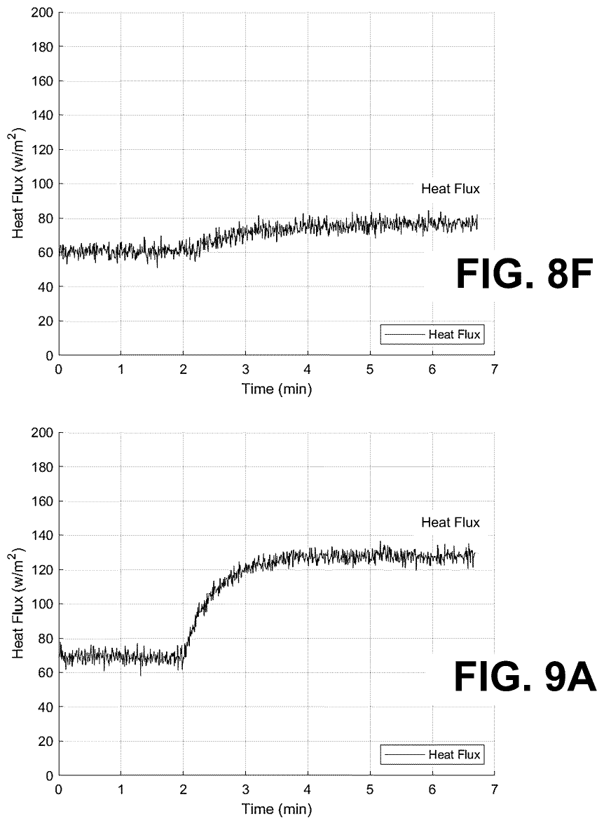

FIG. 8A shows the heat flux for test 2 (1.30 cm water: 0.56 cm 1.5 cSt silicone oil) at 0.5 Hz and 4.4 kVpp. FIG. 8B shows the heat flux for test 2 (1.30 cm water: 0.56 cm 1.5 cSt silicone oil) at 1.0 Hz and 4.2 kVpp. FIG. 8C shows the heat flux for test 2 (1.30 cm water: 0.56 cm 1.5 cSt silicone oil) at 2.0 Hz and 4.3 kVpp. FIG. 8D shows the heat flux for test 2 (1.30 cm water: 0.56 cm 1.5 cSt silicone oil) at 3.0 Hz and 5.5 kVpp. FIG. 8E shows the heat flux for test 2 (1.30 cm water: 0.56 cm 1.5 cSt silicone oil) at 4.0 Hz and 5.8 kVpp. FIG. 8F shows the heat flux for test 2 (1.30 cm water: 0.56 cm 1.5 cSt silicone oil) at 5.0 Hz and 5.5 kVpp.

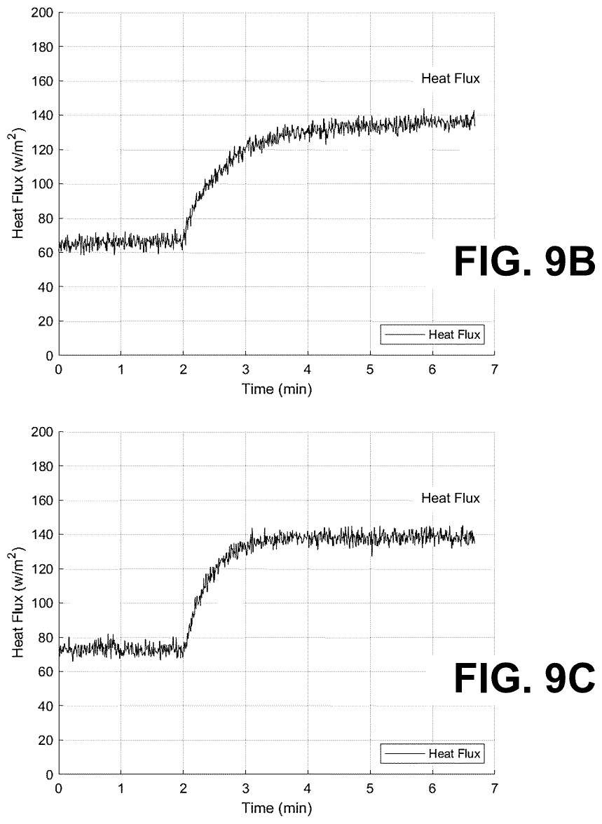

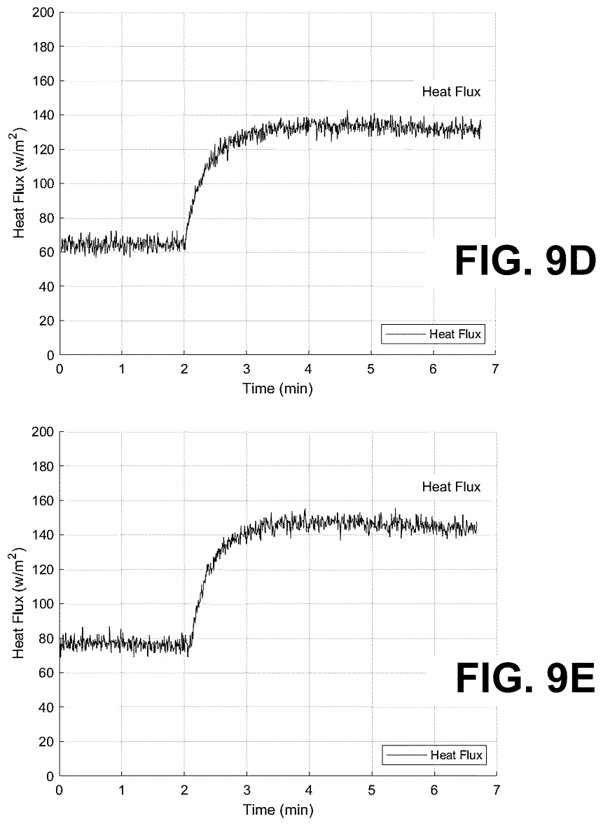

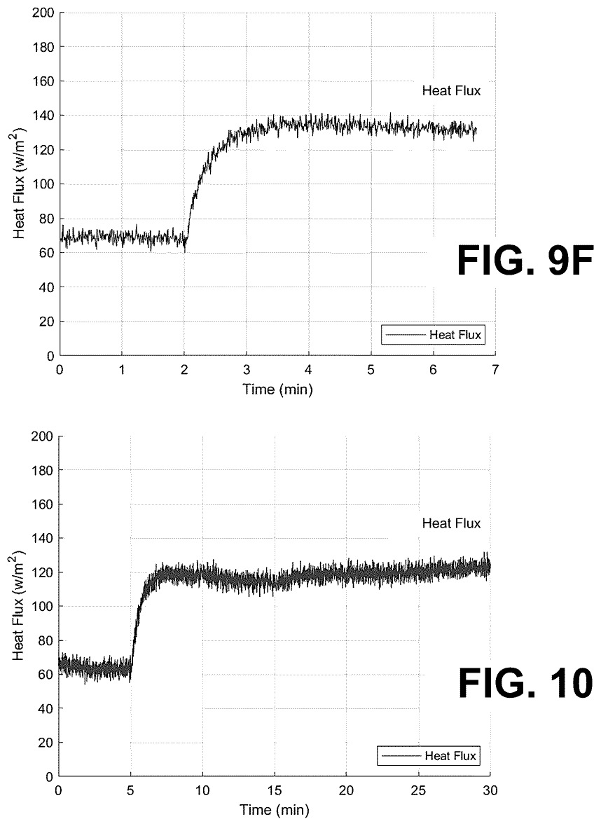

FIG. 9A shows the heat flux for test 3 (0.56 cm water: 1.30 cm 1.5 cSt silicone oil) at 0.5 Hz and 15.2 kVpp. FIG. 9B shows the heat flux for test 3 (0.56 cm water: 1.30 cm 1.5 cSt silicone oil) at 1.0 Hz and 14.0 kVpp. FIG. 9C shows the heat flux for test 3 (0.56 cm water: 1.30 cm 1.5 cSt silicone oil) at 2.0 Hz and 12.0 kVpp. FIG. 9D shows the heat flux for test 3 (0.56 cm water: 1.30 cm 1.5 cSt silicone oil) at 3.0 Hz and 14.5 kVpp. FIG. 9E shows the heat flux for test 3 (0.56 cm water: 1.30 cm 1.5 cSt silicone oil) at 4.0 Hz and 15.6 kVpp. FIG. 9F shows the heat flux for test 3 (0.56 cm water: 1.30 cm 1.5 cSt silicone oil) at 5.0 Hz and 16.2 kVpp.

As shown above, all three tests result in an increase in the heat flux. The greatest increase was shown in the trials with a 30:70 height ratio of water to 1.5 cSt silicone oil. This likely is because more deeply penetrating waves can occur with a greater height of the dielectric fluid. When there is a greater height of the conducting fluid, the waves can only penetrate so far until the conducting fluid reaches the top electrode and can short circuit the system. With greater amounts of dielectric fluid, the conducting fluid has more room to move and convect without reaching the top electrode. The trend appears to hold throughout the three tests.

An additional test was conducted in this phase of testing with test 3 conditions, with a water height of 0.56 cm and silicone oil height of 1.30 cm. This was completed over a longer time frame of 30 minutes total. The first five minutes were at the base state with no forced fluid flow. At the five-minute mark, the AC electric field was applied and forced fluid motion began. The next 25 minutes were with wavelike fluid motion from the electrostatic forcing accompanied by the enhanced heat flux resulting from that motion. FIG. 10 shows the long term heat flux increase with test 3 parameters at 1 Hz and 14.0 kV. It shows that the increase in heat flux is not just limited to a short time interval. It remains fairly constant, with slight deviations likely owing to small temperature differences in the water circulating baths.

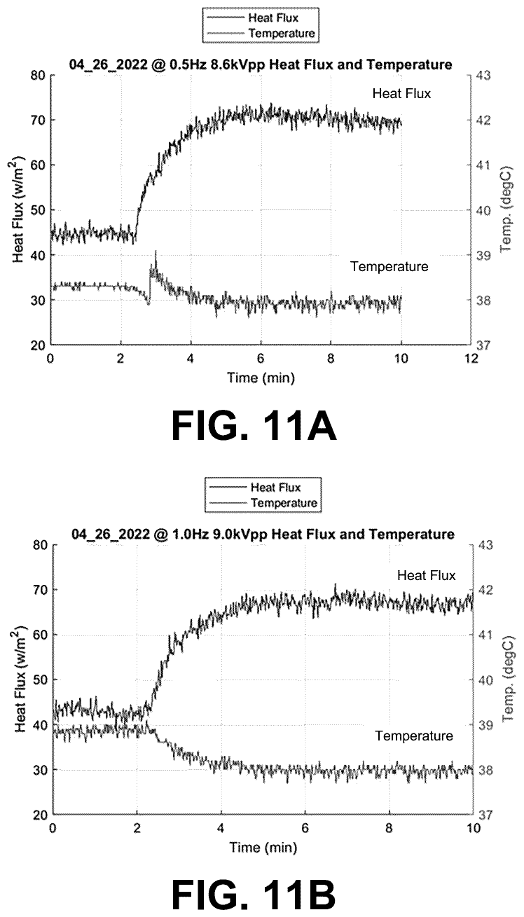

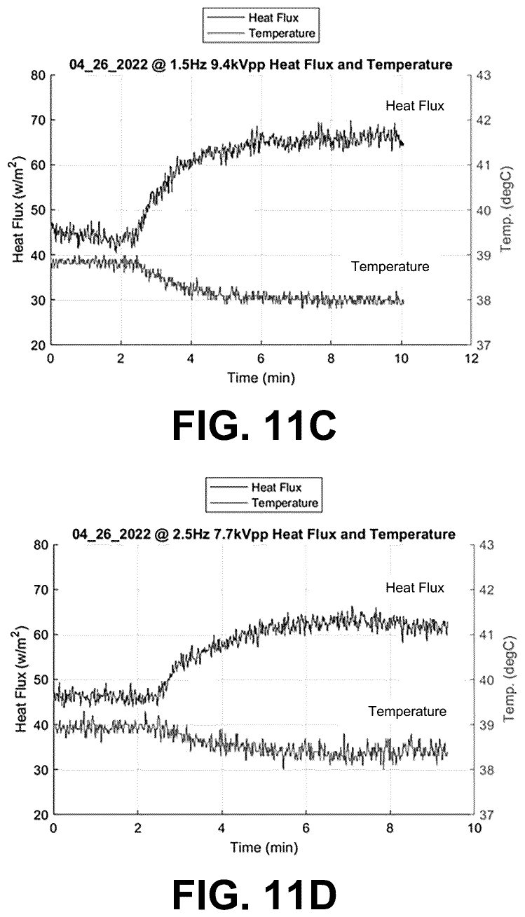

FIG. 11A shows the heat flux and temperature of the system as a function of time. For time 0 to time 2:30, there is no electrostatic field. It is the base steady state heat flux. At time 2:30, an AC electrostatic field is introduced to the system. The frequency is 0.5 Hz with a peak-to-peak voltage of 8.6 kV. This causes a wavelike pattern to form on the fluid interface. It is this vigorous motion that increases the heat flux of the system. As shown, there is an immediate rise in the heat flux which continues for 2 minutes until a new steady state of heat flux is reached. The result is a near 50% increase in heat transfer. The temperature remains nearly constant. As mentioned previously, the optimization of the system parameters should lead to a further increase in heat flux. FIGS. 11B-11C illustrate additional experimental data.

The current physical design, shown in FIG. 5, will have to undergo some changes to continue its development. Future design of this system chiefly includes two phase flow to utilize latent heat. This can be used to greatly increase heat flux. The test cell will primarily be affected by this. Sapphire, whose benefits included its transparency, thermal conduction, and electrical insulation can be replaced with a lower cost electrically insulating and thermally conducting material. The transparency helped to view the wavelike patterns from the bottom of the system in addition to the side view. This was also why we used the ITO coated glass as the electrode on the bottom rather than an opaque metal such as aluminum like we did on the top side. That would not be necessary in a fully functional system. Other considerations include the attachment of the heat source and heat sink.

This novel thermal management system shows promise with a substantial increase in heat flux through electrostatic forcing. The device combines the reliability of active thermal management and the ability of passive thermal management to avoid cavitation and mechanical failure. Under certain test conditions, heat flux increased as much as 109%. The system was also shown to maintain high heat flux over time. Further optimization should continue to yield greater increases in heat flux. Exploration of low melt point liquid metals as the conducting fluid and utilizing phase changes may also lead to greater increases in heat flux. Thus far, we have definitively shown as a proof of concept that electrostatic forcing can be used as a means of thermal management by increasing heat flux.

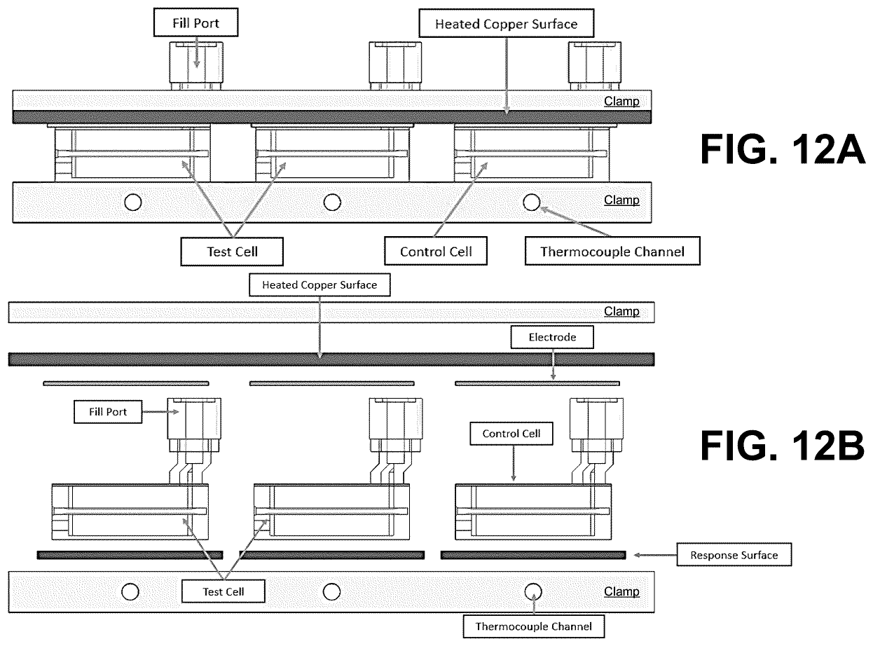

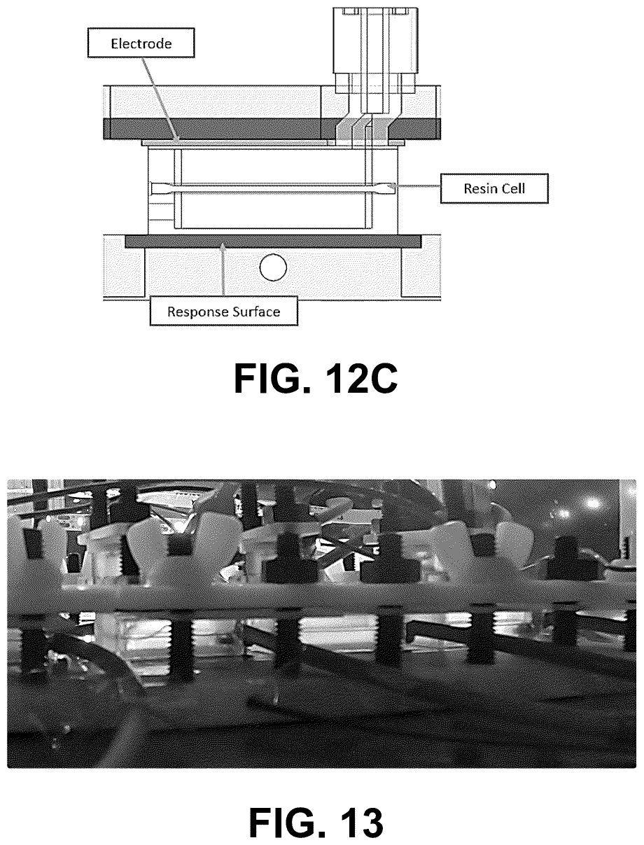

Experimental Setup for Flight Testing. Flight testing was conducted using a multi-unit system. FIG. 12A shows an example of the multi-unit system including a control cell and test cells to conduct the flight testing. FIG. 12B is an exploded view of the multi-unit system. A fluid bilayer was contained within a printed resin cell featuring several components, including a pinning edge and overfill ports. The pinning edge captures the meniscus, effectively pinning the interface at the edges of the container. The overfill port, located at the top of the cell, facilitates the removal of any bubbles that form and allows excess fluid to replenish the system. Because the vapor's low thermal conductivity can reduce the efficiency of heat transfer devices, the function can be important.

FIG. 12C shows details of the individual heat transfer cells of the multi-unit system. The resin cell was sandwiched between two copper plates secured by 3D printed polylactic acid (PLA) components. The top copper plate included an attached resistive heater, insulated by a 3D-printed part that also slotted over the cell's overfill ports. The bottom PLA part featured slots that house the bottom copper plate, holding it securely in place. This bottom copper plate, which lacks external heating, serves as a passive element to observe heat transfer. Alongside the bottom PLA part, through-holes are provided to accommodate thermocouples, which were securely positioned on the copper plate.

To assemble the system, 3″ nylon screws were placed through the printed parts and tightened with the nylon wing nuts, creating a compression-fit structure that holds all components securely. To operate the system, a voltage and frequency were input across the electrodes, inducing wave-like patterns that enhance heat transfer, measured using thermocouples. To isolate the heat transfer increase due to resonance from other mechanisms, the forced test cell was directly compared with a control cell. The control cell operates under identical conditions but was left undisturbed, ensuring any temperature rise from pure conduction was excluded from the experimental results. FIG. 13 is an image of the fabricated multi-unit system used in the flight testing.

Thermal Design Aspect. The top copper plate was equipped with a resistive heater, which maintained the hot side of the system at a constant temperature. This temperature was regulated by a PID-controlled temperature controller to ensure precise thermal control.

The resistive heater was in direct contact with the copper plate, allowing the heat to be evenly distributed. The copper plate was secured in place by a 3D-printed PLA component. On the bottom side, the water phase was separated by a thin resin layer, which transfers heat from the water to a conductive copper plate beneath it. While the resin has lower thermal conductivity, its thin profile minimizes thermal resistance, ensuring it will not impede heat transfer significantly.

To monitor temperature changes, a pair of thermocouples was positioned below the thin resin layer. These thermocouples measure the response temperature of the bottom copper plate, enabling the observation of heat transfer dynamics in the system.

Electrical Design Aspect. From an electrical perspective, a system comprising a ground electrode and a live electrode was constructed and provides a circuit through the fluids. One fluid is a good conductor, while one fluid is a good dielectric. The grounded electrode was the top electrode and was made of copper, while the live electrode was connected to a stainless steel screw in contact with the conducting fluid or the bottom fluid.

Both electrodes were insulated with resin, ensuring electrical current flows through the fluids as designed. The electrical leads were connected to a high voltage amplifier (e.g., Trek Model 609B 1000× voltage amplifier), which amplified the input signal. The input signal was supplied by a function waveform generator (e.g., Siglent 30 MHz function waveform generator), allowing for a wide range of input frequencies and voltages.

The heating system was regulated by a standard temperature controller (e.g., Omega CN7533 1/32 DIN), which was wired directly from a power outlet to the resistive heater, ensuring precise thermal management during operation.

Experimental Results. Numerous sets of trials were conducted to evaluate the effectiveness of resonant induced heat transfer under reduced gravity conditions and various forcing conditions to optimize operation. In all trials, the upper boundary temperature was set above ambient conditions, while the lower boundary temperature remained uncontrolled. The upper boundary temperature, T_{H}, was set to 50° C. and maintained at a constant temperature throughout the experiments. The temperature at the lower boundary, T_{R}, was monitored to measure the system's thermal response.

To assess the enhancement of heat transfer, a normalized temperature, Tₙₒᵣₘ, was calculated. This parameter evaluates the increase in response temperature relative to the initial temperature difference, enabling direct comparison between trials. Tₙₒᵣₘ is defined by:

$${T}_{norm} = \frac{{T}_{R} - {T}_{R 0}}{{T}_{H} - {T}_{R 0}} * 100 \qquad ( 1 )$$

where T_{R0} is the initial response temperature at the start of a trial. To quantify the improvement in heat transfer due to electrostatic resonance, the normalized temperature response of the control cell was subtracted from that of the forced cell. This improvement metric is expressed as:

$$Improvement = {T}_{Norm , Forced} - {T}_{Norm , Control} . \qquad ( 2 )$$

The fluid pairing used in experiments consisted of distilled water as the conducting fluid and 1.5 cSt. silicone oil as the dielectric. Water, being denser, formed the lower phase, while the silicone oil formed the upper phase. The fluid:height ratio was maintained at 50:50, with each layer measuring 6 mm in height. The test cell dimensions were 30 mm in width and 10 mm in depth. The narrow geometry of the cell restricted interfacial patterns to form exclusively along the width direction.

Testing was performed at variable gravity levels to test the effectiveness of resonance-induced convection for heat transfer applications. Testing under terrestrial gravity allowed for extended time durations to observe long-term effects, whereas trials in lunar and microgravity conditions were performed during parabolic flights with strict time constraints, averaging 15 seconds per trial. The image of FIG. 13 shows the physical experiment used on a parabolic flight for reduced gravity testing. The test cell on the left has a deflected interface due to electrostatic forcing.

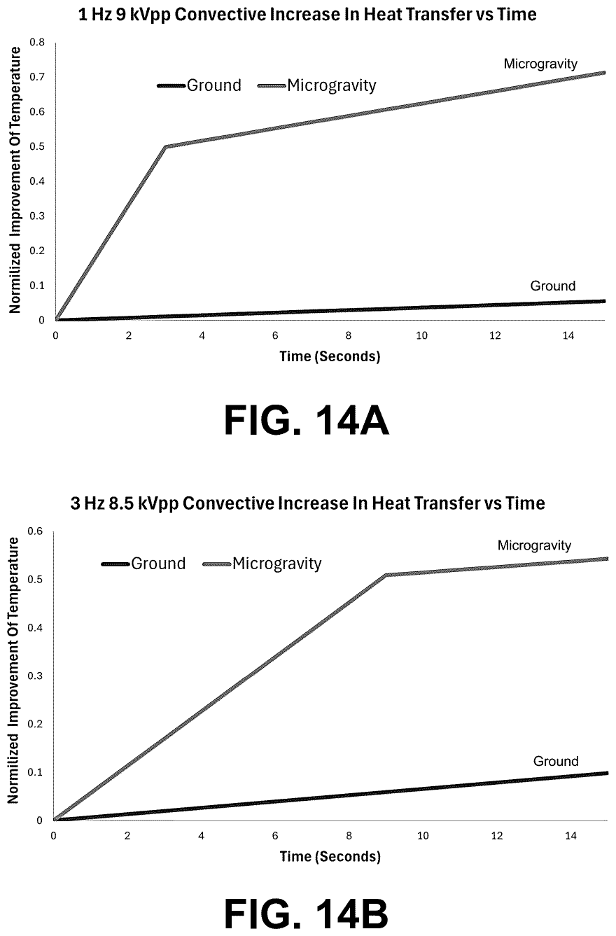

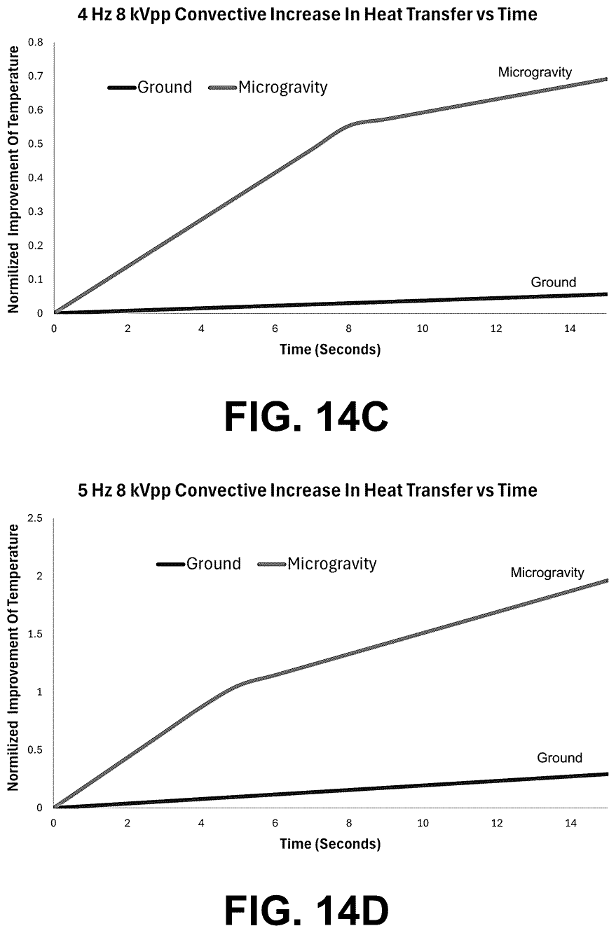

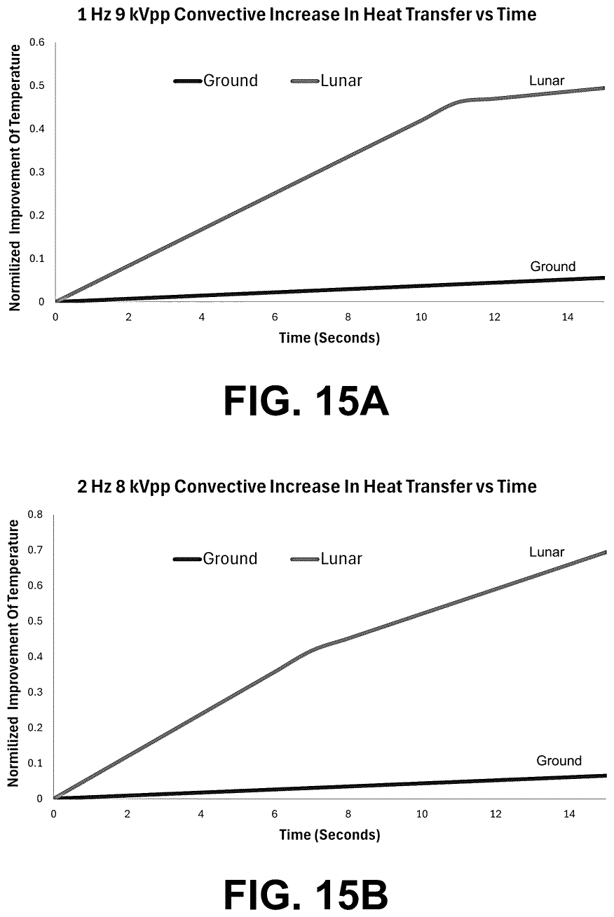

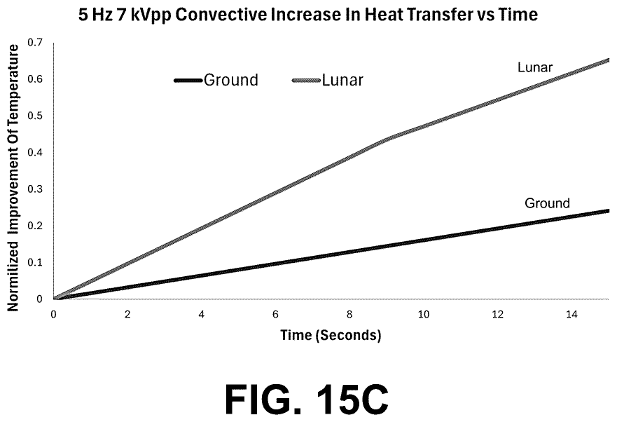

The collected data, summarized in Table 2, demonstrate clear trends in heat transfer enhancement across different frequencies and voltages. Results presented in FIGS. 14A-14D illustrate the improvements observed under microgravity compared to terrestrial gravity conditions. For example, FIG. 14A shows enhancement at 1 Hz and 9 kVpp, FIG. 14B at 3 Hz and 8.5 kVpp, FIG. 14C at 4 Hz and 8 kVpp, and FIG. 14D at 5 Hz and 8 kVpp. Additional data comparing improvements at lunar and terrestrial gravity conditions are presented in FIGS. 15A-15C. Enhancement is shown in FIG. 15A at 1 Hz and 9 kVpp, FIG. 15B at 2 Hz and 8 kVpp, and FIG. 15C at 5 Hz and 7 kVpp.

TABLE 2
Comparison of ground and flight experiments

| | | Normalized | Normalized | |
|---|---|---|---|---|
| | | Ground | Microgravity | |
| Frequency | Voltage | Improvement | Improvement | Improvement |
| (Hz) | (kVpp) | (a.u.) | (a.u.) | Ratio |
| 1 | 9 | 0.05526 | 0.7127 | 12.90 |
| 3 | 8.5 | 0.09855 | 0.5430 | 5.51 |
| 4 | 8 | 0.05672 | 0.6913 | 12.19 |
| 5 | 8 | 0.2914 | 1.964 | 6.74 |

The results consistently demonstrate significant enhancements in heat transfer under reduced gravity conditions, likely driven by stronger resonance-induced interfacial flows compared to terrestrial environments. Gravity primarily influences the system by providing stabilization against electrostatic forcing. In reduced gravity, resonance-driven convection becomes the dominant mechanism of heat transfer over conduction.

The experimental design of FIGS. 12A-12C represents one possible implementation of the heat transfer system technology, which can be further developed. Modifications can include improvements to the test cell design and integration of sensors to measure heat flux directly. For example, heat flux measurements can be implemented by maintaining a constant temperature gradient and improving insulation to minimize heat losses.

The results of this study demonstrate the novelty and effectiveness of resonance induced heat transfer, especially in reduced gravity environments, and highlight its potential for advanced thermal management applications. Although this implementation represents an preliminary prototype, it establishes a foundation for further refinements and optimizations while preserving the core principle of electrostatic resonance-driven convection. The described approach and its underlying principles are protected within the scope of the disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A heat transfer system, comprising:
a cell comprising fluids;
an aluminum electrode clamped on a first side of the cell; and
an ITO-coated glass electrode clamped on a second side of the cell;
wherein AC excitation of the aluminum electrode and the ITO-coated electrode produces AC electrostatic fields that resonate the fluids enhancing heat transfer across the cell.

2. The heat transfer system of claim 1, comprising a first electrically insulating and thermally conducting material positioned on a side of the aluminum electrode opposite the cell and a second electrically insulating and thermally conducting material positioned on a side of the ITO-coated glass electrode opposite the cell.

3. The heat transfer system of claim 2, wherein the first and second electrically insulating and thermally conducting materials are sapphire.

4. The heat transfer system of claim 2, comprising a first water bath positioned on a side of the first electrically insulating and thermally conducting material opposite the aluminum electrode and a second water bath positioned on a side of the second electrically insulating and thermally conducting material opposite the ITO-coated electrode.

5. The heat transfer system of claim 4, wherein the second water bath is sealed by the second electrically insulating and thermally conducting material using a clamp.

6. The heat transfer system of claim 5, wherein the cell is secured between the aluminum electrode and the ITO-coated glass electrode using a second clamp.

7. The heat transfer system of claim 6, wherein both clamps have low thermal conductivity.

8. The heat transfer system of claim 7, wherein the clamps are PLA (polylactic acid) clamps.

9. The heat transfer system of claim 4, wherein the first and second water baths are fabricated of resin.

10. The heat transfer system of claim 1, comprising a heat flow sensor.

11. The heat transfer system of claim 10, wherein the heat flow sensor is located between the aluminum electrode and a first water bath positioned on a side of the aluminum electrode opposite the cell.

12. The heat transfer system of claim 10, wherein the heat flow sensor is secured between electrically insulating and thermally conducting material.

13. The heat transfer system of claim 1, wherein the cell is a polycarbonate test cell.

14. The heat transfer system of claim 1, wherein the cell comprises a first fluid having a first density and a second fluid having a second density greater than the first density.

15. The heat transfer system of claim 14, wherein the first fluid is an oil and the second fluid is water.

16. The heat transfer system of claim 15, wherein the oil is a silicone oil.

17. The heat transfer system of claim 14, wherein the ratio of the first fluid to the second fluid is in a range from about 30:70 to about 70:30.

18. The heat transfer system of claim 17, wherein the ratio is a height ratio in the cell.

19. The heat transfer system of claim 1, wherein the AC excitation is provided in a range from about 0.5 Hz to about 5 Hz.

20. The heat transfer system of claim 1, wherein the AC excitation is applied to the aluminum electrode and the ITO-coated electrode in a microgravity environment without gravity driven buoyancy.

21. The heat transfer system of claim 1, comprising a fill port configured to provide the fluids to the cell.

22. The heat transfer system of claim 1, comprising:
a plurality of the cells, each cell comprising the fluid;
electrodes clamped on first and second sides of each cell; and
first and second low thermal conductivity clamps securing the electrodes on the first and second sides of each of the plurality of cells.
